(19) United States
(12) Patent Application Publication
(10) Pub. No.: US 2018/0121926 A1
(43) Pub. Date: May 3, 2018

(54) METHODS AND APPARATUS FOR AUTHORIZING AUTOMATED TELLER MACHINE TRANSACTIONS USING BIOMETRIC DATA

(71) Applicant: MASTERCARD INTERNATIONAL INCORPORATED, Purchase, NY (US)

(72) Inventors: Piyush Sharma, Pune (IN); Elson Rodrigues, Mumbai (IN)

(21) Appl. No.: 15/799,558

(22) Filed: Oct. 31, 2017

(30) Foreign Application Priority Data
Nov. 1, 2016 (SG) 10201609117T

(51) Int. Cl. G06Q 20/40; G06Q 20/10; G07F 19/00; G06Q 20/32

(52) U.S. Cl. CPC G06Q 20/40145; G06Q 20/1085; G06Q 2220/00; G06Q 20/3274; G06Q 20/4012; G07F 19/206

(57) ABSTRACT

A method using an automated teller machine of processing a transaction is provided. The method includes receiving inputs indicating an account identifier and a unique personal identifier of a customer, sensing biometric data of the customer using a biometric sensor, receiving a transaction indication indicating a transaction, and generating a transaction authorization request. The transaction authorization request includes the account identifier, the unique personal identifier of the customer, the biometric data of the customer, and the transaction indication.

### CROSS REFERENCE TO RELATED APPLICATIONS

This patent application claims priority to Singapore Application No. SG 10201609117T, filed on Nov. 1, 2016, the disclosure of which is incorporated by reference herein in its entirety as part of the present application.

### BACKGROUND

The present disclosure relates to methods and apparatus authorizing automated teller machine (ATM) transactions. In particular, it provides methods and systems for authorizing ATM transactions using biometric data of a customer.

Automated teller machines (ATMs) are part and parcel of everyone's life today. They provide an extension to the banking infrastructure and prove to be a boon in terms of accessibility and availability. In developing countries such as India, there is a large ‘unbanked population’ living in remote villages. To reach such communities, governments and banks have come up with the concept of ‘white label’ ATMs, in which the ATMs are owned by private parties.

A problem faced by these communities is that a high level of logistics is required for the issuance of cards and PIN numbers. For example, for a remote location, logistics services are very poor. Although there exists a mechanism to withdraw money for these communities, for example a ‘white label’ ATM, there are still difficulties for the community to access the banking facilities. Such problems are often compounded by low levels of literacy in these communities, resulting in consumers that have difficulty remembering information such as bank account numbers and PIN numbers.

### BRIEF SUMMARY

In general terms, the present disclosure proposes a method of authorizing ATM transactions using biometric data. The proposed methods involve authorizing transactions using a unique personal identifier of a customer in combination with biometric data of the customer. The combination of the biometric data and the unique personal identifier is used to validate the customer by a biometric data authentication server. For example, the methods described herein may utilize the AADHAR numbers provided to Indian citizens by the Unique Identification Authority of India (UIDAI). The UIDAI provides a Central Identities Data Repository (CIDR) for verification. This can be used to validate a customer. The validation process involves the submission of the AADHAR number along with biometric data of the customer to the CIDR. In response, the CIDR verifies whether the data submitted matches the data available in CIDR and responds with an indication of whether the biometric data submitted corresponds to the AADHAR number submitted. Using such verification for ATM transactions allows the transactions to be authenticated without the need for a PIN number or magnetic card.

According to a first aspect of the present disclosure, there is provided a method in an automated teller machine of processing a transaction. The method includes receiving inputs indicating an account identifier and a unique personal identifier of a customer, sensing biometric data of the customer using a biometric sensor, receiving a transaction indication indicating a transaction, and generating a transaction authorization request, the transaction authorization request comprising the account identifier, the unique personal identifier of the customer, the biometric data of the customer, and the transaction indication.

The inputs indicating an account identifier and a unique personal identifier of a customer may be received by scanning a machine readable code with a scanner. The machine readable code may indicate the account identifier and the unique personal identifier of the customer. The machine readable code may be an optical code such as a QR code.

In an embodiment the method further includes receiving a user selection of a unique personal identifier authenticated transaction.

The unique personal identifier may be an identification number, such as an AADHAR number.

In an embodiment, the transaction authorization request is formatted according to the ISO 8583 standard. The biometric data of the customer may be included in data element 63 of the transaction authorization request.

According to a second aspect of the present disclosure there is provided a method, in a server, of authorizing an automated teller machine transaction. The method includes receiving, at the server, a transaction authorization request, the transaction authorization request including an indication of an account identifier, an indication of a unique personal identifier of a customer, and an indication of biometric data for the customer, generating a customer verification request based on the unique personal identifier of the customer and the biometric data of the customer, sending the customer verification request to a biometric data authentication server, receiving a customer verification response from the biometric data authentication server, and generating a transaction authorization response based on the customer verification response.

In an embodiment the method further includes looking up customer contact information in a database and sending a transaction notification to the customer using the customer contact information. The customer contact information may include a mobile telephone number associated with the customer, and the transaction notification can be sent as a text message.

According to a third aspect of the present disclosure there is provided an automated teller machine including a biometric sensor, a computer processor and a data storage device, the data storage device having transaction authorization request generation module including non-transitory instructions operative by the processor to receive inputs indicating an account identifier and a unique personal identifier of a customer, sense biometric data of the customer using the biometric sensor, receive a transaction indication indicating a transaction, and generate a transaction authorization request, the transaction authorization request including the account identifier, the unique personal identifier of the customer, the biometric data of the customer, and the transaction indication.

According to a fourth aspect of the present disclosure there is provided an apparatus for authorizing an automated teller machine transaction. The apparatus includes a computer processor and a data storage device, the data storage device having a customer verification module and a transaction authorization module including non-transitory instructions operative by the processor to receive a transaction authorization request, the transaction authorization request including an indication of an account identifier, an indication of a unique personal identifier of a customer, and an indication of biometric data for the customer, generate a customer verification request based on the unique personal identifier of the customer and the biometric data of the customer, send the customer verification request to a biometric data authentication server, receive a customer verification response from the biometric data authentication server, and generate a transaction authorization response based on the customer verification response.

According to a yet further aspect, there is provided a non-transitory computer-readable medium. The computer-readable medium has stored thereon program instructions for causing at least one processor to perform operations of a method disclosed above.

### BRIEF DESCRIPTION OF THE DRAWINGS

Embodiments of the disclosure will now be described for the sake of non-limiting example only, with reference to the following drawings in which:

FIG. 1 is a block diagram showing a system for authorizing automated teller machine (ATM) transactions according to an embodiment of the present disclosure;

FIG. 2 is a block diagram showing a technical architecture of an ATM according to an embodiment of the present disclosure;

FIG. 3 is a block diagram showing a technical architecture of a transaction processing server according to an embodiment of the present disclosure; and

FIG. 4 is a flow chart showing a method of authorizing an ATM transaction according to an embodiment of the present disclosure.

### DETAILED DESCRIPTION

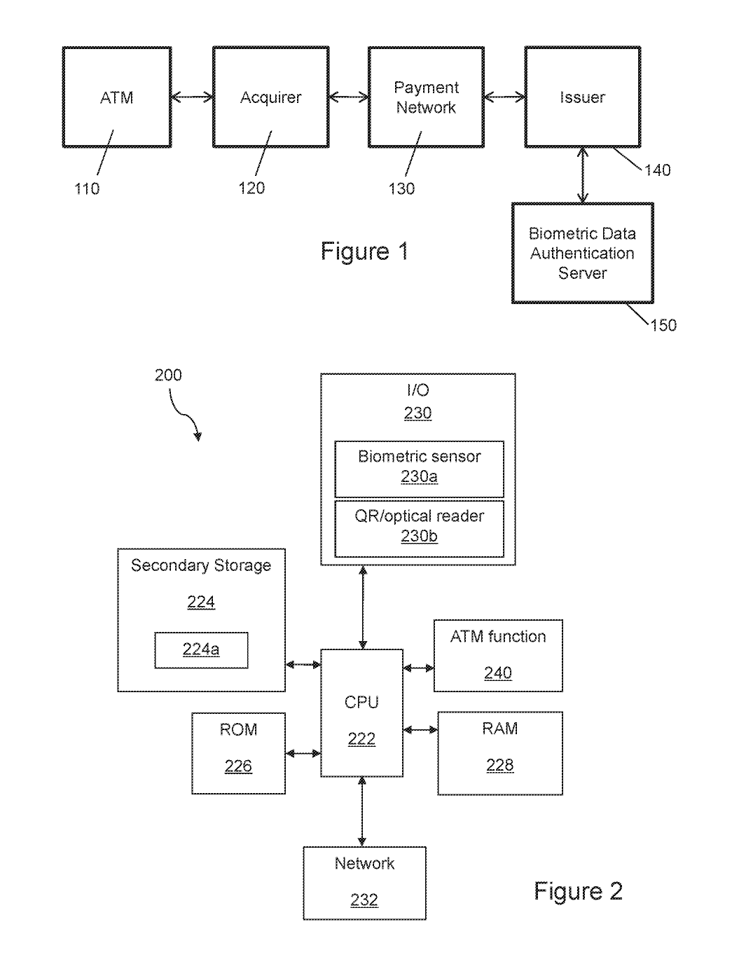

FIG. 1 is a block diagram showing a system for authorizing automated teller machine (ATM) transactions according to an embodiment of the present disclosure. The system includes an ATM 110. The ATM 110 is connected by a network to an Acquirer server 120. The Acquirer server 120 is connected to a payment network 130.

Non-limiting examples of the payment network 130 include a payment card type of network such as the payment processing network operated by MasterCard. The various communication may take place via any types of network, for example, virtual private network (VPN), the Internet, a local area and/or wide area network (LAN and/or WAN), and so on.

The payment network 130 is connected to an Issuer server 140. The Issuer server 140 has a connection to a Biometric Data Authentication Server 150.

As described in more detail below, the ATM 110 has an optical reader such as a barcode scanner or a QR code reader and a biometric reader such as a finger print scanner. Examples of ATM models with these functionalities are Vortex Eco-teller and NCR SS22e.

The connections between the ATM 110, the acquirer server 120, the payment network 130, the issuer server 140, and the biometric data authentication server 150 may be a wired or wireless connection or a combination of the two.

An example of a biometric data authentication server 150 which may be used in embodiments of the present disclosure is the Central Identities Data Repository (CIDR) implemented by the Unique Identification Authority of India (UIDAI). The UIDAI provides citizens of India with a unique 12 digit number, known as an AADHAR number. The CIDR stores biometric data for each citizen with an AADHAR number and can be used to authenticate the biometric data of citizens. In response to a biometric data verification request including an AADHAR number and biometric data such as a finger print, the CIDR provides an authentication response. The authentication response indicates whether the biometric data matches the biometric data stored for the submitted AADHAR number.

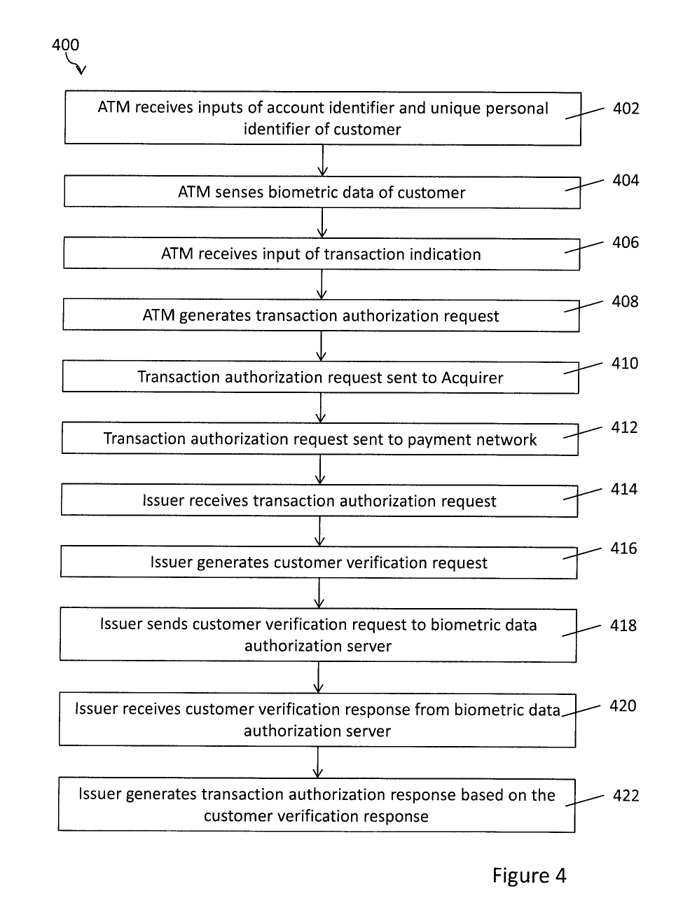

FIG. 2 is a block diagram showing a technical architecture 200 of the ATM 110 for steps of performing an exemplary method 400 which is described below with reference to FIG. 4. Typically, the method 400 is implemented by a number of computers each having a data-processing unit. The block diagram as shown in FIG. 2 illustrates a technical architecture 200 an ATM which is suitable for implementing one or more embodiments herein.

The technical architecture 200 includes a processor 222 (which may be referred to as a central processor unit or CPU) that is in communication with memory devices including secondary storage 224 (such as disk drives), read only memory (ROM) 226, random access memory (RAM) 228. The processor 322 may be implemented as one or more CPU chips. The technical architecture 220 may further include input/output (I/O) devices 230, and network connectivity devices 232. The technical architecture 200 further includes an ATM function 240 which provides ATM functions such as cash dispensing.

The secondary storage 224 typically includes one or more disk drives or tape drives and is used for non-volatile storage of data and as an over-flow data storage device if RAM 228 is not large enough to hold all working data. Secondary storage 324 may be used to store programs which are loaded into RAM 228 when such programs are selected for execution. In this embodiment, the secondary storage 224 has an authorization request generation module 224a including non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 include a biometric sensor 230a such as a fingerprint scanner, and an optical reader such as a barcode or QR code reader. The I/O devices may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 326, RAM 328, or the network connectivity devices 232. While only one processor 222 is shown, multiple processors may be present. Thus, while instructions may be discussed as executed by a processor, the instructions may be executed simultaneously, serially, or otherwise executed by one or multiple processors.

It is understood that by programming and/or loading executable instructions onto the technical architecture 200, at least one of the CPU 222, the RAM 228, and the ROM 226 are changed, transforming the technical architecture 200 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Although the technical architecture 200 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 200 to provide the functionality of a number of servers that is not directly bound to the number of computers in the technical architecture 200. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

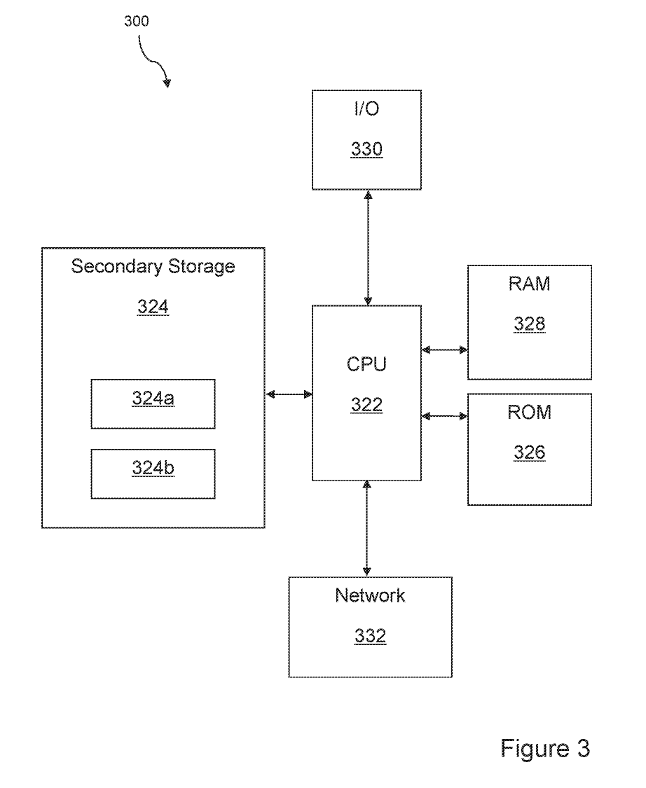

FIG. 3 is a block diagram showing a technical architecture 300 of the issuer server 140 for performing steps of an exemplary method 400 which is described below with reference to FIG. 4. Typically, the method 400 is implemented by a number of computers each having a data-processing unit. The block diagram as shown in FIG. 3 illustrates a technical architecture 300 a computer which is suitable for implementing one or more embodiments herein.

The technical architecture 300 includes a processor 322 (which may be referred to as a central processor unit or CPU) that is in communication with memory devices including secondary storage 324 (such as disk drives), read only memory (ROM) 326, random access memory (RAM) 328. The processor 322 may be implemented as one or more CPU chips. The technical architecture 320 may further include input/output (I/O) devices 330, and network connectivity devices 332.

The secondary storage 324 typically includes one or more disk drives or tape drives and is used for non-volatile storage of data and as an over-flow data storage device if RAM 328 is not large enough to hold all working data. Secondary storage 324 may be used to store programs which are loaded into RAM 328 when such programs are selected for execution. In this embodiment, the secondary storage 324 has a customer verification module 324a, a customer look up module 324b, and a transaction authorization transaction matching module 324c comprising non-transitory instructions operative by the processor 322 to perform various operations of the method of the present disclosure. The ROM 326 is used to store instructions and perhaps data which are read during program execution. The secondary storage 324, the RAM 328, and/or the ROM 326 may be referred to in some contexts as computer readable storage media and/or non-transitory computer readable media.

I/O devices 330 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 332 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 332 may enable the processor 322 to communicate with the Internet or one or more intranets. With such a network connection, it is contemplated that the processor 322 might receive information from the network, or might output information to the network in the course of performing the above-described method operations. Such information, which is often represented as a sequence of instructions to be executed using processor 322, may be received from and outputted to the network, for example, in the form of a computer data signal embodied in a carrier wave.

The processor 322 executes instructions, codes, computer programs, scripts which it accesses from hard disk, floppy disk, optical disk (these various disk based systems may all be considered secondary storage 324), flash drive, ROM 326, RAM 328, or the network connectivity devices 332. While only one processor 322 is shown, multiple processors may be present. Thus, while instructions may be discussed as executed by a processor, the instructions may be executed simultaneously, serially, or otherwise executed by one or multiple processors.

It is understood that by programming and/or loading executable instructions onto the technical architecture 300, at least one of the CPU 322, the RAM 328, and the ROM 326 are changed, transforming the technical architecture 300 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Although the technical architecture 300 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 300 to provide the functionality of a number of servers that is not directly bound to the number of computers in the technical architecture 300. In an embodiment, the functionality disclosed above may be provided by executing the application and/or applications in a cloud computing environment. Cloud computing may include providing computing services via a network connection using dynamically scalable computing resources. A cloud computing environment may be established by an enterprise and/or may be hired on an as-needed basis from a third party provider.

Various operations of the exemplary method 400 will now be described with reference to FIG. 4 in respect of authorizing an ATM transaction. It should be noted that enumeration of operations is for purposes of clarity and that the operations need not be performed in the order implied by the enumeration.

FIG. 4 is a flow chart showing a method of authorizing an ATM transaction according to an embodiment of the present disclosure.

In step 402, the ATM 110 receives inputs of an account identifier and a unique personal identifier of a customer. These may be entered by the customer using a keypad of the ATM 110. Alternatively, the customer may be supplied with bank passbook or card having an optical code such as a QR code with the details such as customer account number and unique identification number, for example AADHAR number encoded in the optical code.

The AADHAR number and valid customer details, which may be required by the issuer to validate can be stored in QR code. There are following benefits of using a QR code. A QR reader is present in many ATMs, for example NCR SS22E, and Vortex Ecoteller. QR code is an encrypted methodology to store data. Relevant information can be stored in it which may be required by issuer to validate the transaction. The consumer is not required to remember his or her AADHAR number. That can be encrypted in the QR code.

Prior to step 402, the customer may be presented with options for either a conventional card and PIN based transaction or a biometric and identification number based transaction. If the customer selected the second option, the optical reader 230b of the ATM 110 is activated and the Once, the customer selects AADHAR based transaction screen, the light of the QR reader or barcode reader shall glow. This shall indicate activation of the QR read state. Once QR Card/Logo is presented by the customer to the reader, the reader shall fetch details and present on the screen. This QR code shall be provided by the issuer bank in his passbook once he receives his account opening info from issuer. This service has to be opted by the cardholder at the time of Account opening. Also, the QR code may be provided printed on the card issued to customer.

In step 404, the biometric sensor 230a of the ATM 110 senses the biometric data of the customer. This may involve, for example, the customer being prompted to post his finger in a finger print scanner for authentication. This shall be validated with data stored at the biometric data authentication server 150. Once Biometric is presented the transaction shall move to the issuer for authorization.

In step 406, the ATM 110 receives an input of a transaction indication. The transaction indication may indicate a transaction type, for example a withdrawal or transfer, a transaction amount and other transaction information.

In step 408, the ATM 110 generates a transaction authorization request. The transaction authorization request may be in the NDC (NCR Direct Connect) format. The transaction authorization request contains the biometric data. The biometric data may be stored according to UIDAI standards and may be contained in a reserve field of the authorization request in the NDC format.

In step 410, the transaction authorization request is sent to the Acquirer server 120. The Acquirer server may add a flag to the transaction authorization request to indicate to the payment network that the transaction is a biometric transaction to the payment network.

In step 412, the Acquirer server 120 sends the transaction authorization request to the payment network 130. The payment network 130 then sends the transaction authorization request to the issuer server 140.

The issuer server 140 receives the transaction authorization request in step 414. The transaction authorization request may be formatted according to the ISO 8583 standard and the biometric data of the customer may be included in data element 63 of the transaction authorization request. Alternatively any other reserve field of the authorization request may be used.

In step 416 the issuer server 140 generates a customer verification request. The customer verification request contains the unique identifier of the customer and the biometric data of the customer both of which are extracted from the transaction authorization request by the issuer server 140.

In step 418 the issuer server sends the customer verification request to the biometric data authentication server 150. The biometric data authentication server 150 checks whether the biometric data contained within the customer verification request is a match for the customer having the unique identifier contained within the customer verification request. The biometric data authentication server 150 then generates a customer verification response indicating whether the biometric data for the customer corresponds to the biometric data stored against unique identifier for the customer.

In step 420 the issuer server 140 receives the customer verification response from the biometric data verification server 150.

In step 422 the issuer server generates a transaction authorization response using the customer verification response received from the biometric data authentication server 150. The decision to approve or disapprove a transaction shall rest completely with the Issuer. In embodiments there are no Stand-In services for these types of biometric transactions. When making a decision to authorize the transaction, the issuer server 140 may take into account factors such as the account balance of customer.

Once a transaction is authorized, the transaction authorization response is shall be sent across to the Acquirer server 120 through the payment network 130.

The issuer server 140 may generate a message which is sent to the customer to indicate that the transaction has been successful. In an embodiment, the issuer server 140 looks up customer contact information in a database using the customer's unique identifier or an account number associated with the customer. The contact information may be for example a mobile telephone number. The issuer server 140 may use this mobile telephone number to send a text message to the customer indicating that the transaction has been successfully authorized.

Whilst the foregoing description has described exemplary embodiments, it will be understood by those skilled in the art that many variations of the embodiment can be made within the scope and spirit of the present disclosure.

1. A method for using an automated teller machine to process a transaction, the method comprising:
receiving inputs indicating an account identifier and a unique personal identifier of a customer;
sensing biometric data of the customer using a biometric sensor;
receiving a transaction indication indicating a transaction; and
generating a transaction authorization request, wherein the transaction authorization request includes the account identifier, the unique personal identifier of the customer, the biometric data of the customer, and the transaction indication.

2. A method according to claim 1, wherein receiving inputs indicating an account identifier and a unique personal identifier of a customer comprises scanning a machine readable code with a scanner, the machine readable code indicating the account identifier and the unique personal identifier of the customer.

3. A method according to claim 2, wherein the machine readable code is an optical code.

4. A method according to claim 3, wherein the optical code is a QR code.

5. A method according to claim 1, further comprising receiving a user selection of a unique personal identifier authenticated transaction.

6. A method according to claim 1, wherein the unique personal identifier is an identification number.

7. A method according to claim 6 wherein the identification number is an AADHAR number.

8. A method according to claim 1, wherein the transaction authorization request is formatted according to the ISO 8583 standard.

9. A method according to claim 8 wherein the biometric data of the customer is included in data element 63 of the transaction authorization request.

10. A computer readable medium carrying computer executable instructions which when executed on a processor cause the processor to carry out the method according to claim 1.

11. A method, implemented using a server, for authorizing an automated teller machine transaction, the method comprising:
receiving, at the server, a transaction authorization request, wherein the transaction authorization request includes an indication of an account identifier, an indication of a unique personal identifier of a customer, and an indication of biometric data for the customer;
generating a customer verification request based on the unique personal identifier of the customer and the biometric data of the customer;
sending the customer verification request to a biometric data authentication server;
receiving a customer verification response from the biometric data authentication server; and
generating a transaction authorization response based on the customer verification response.

12. A method according to claim 11, further comprising looking up customer contact information in a database and sending a transaction notification to the customer using the customer contact information.

13. A method according to claim 12, wherein the customer contact information includes a mobile telephone number associated with the customer, and wherein the transaction notification is sent as a text message.

14. A computer readable medium carrying computer executable instructions which when executed on a processor cause the processor to carry out the method according to claim 11.

15. An automated teller machine comprising:
a biometric sensor;
a computer processor and a data storage device, wherein the data storage device comprises a transaction authorization request generation module comprising non-transitory instructions executable by the computer processor to:
receive inputs indicating an account identifier and a unique personal identifier of a customer;
sense biometric data of the customer using the biometric sensor;
receive a transaction indication indicating a transaction; and
generate a transaction authorization request, wherein the transaction authorization request includes the account identifier, the unique personal identifier of the customer, the biometric data of the customer, and the transaction indication.

16. An automated teller machine according to claim 15, further comprising a scanner operable to scan a machine readable code, wherein the scanner is operable to receive inputs indicating the account identifier and the unique personal identifier of the customer by scanning a machine readable code.

17. An automated teller machine according to claim 16, wherein the scanner is an optical scanner operable to read an optical code, and wherein the machine readable code is an optical code.

18. An automated teller machine according to claim 17, wherein the optical code is a QR code.

19. An automated teller machine according to claim 15, further comprising a user interface operable to receive a user selection of a unique personal identifier authenticated transaction.

20. An automated teller machine according to claim 19, wherein the unique personal identifier is an identification number.

21. An automated teller machine according to claim 20, wherein the identification number is an AADHAR number.

22. An automated teller machine according to claim 15, wherein the transaction authorization request is formatted according to the ISO 8583 standard.

23. An automated teller machine according to claim 15, wherein the biometric data of the customer is included in data element 63 of the transaction authorization request.

24. An apparatus for authorizing an automated teller machine transaction, the apparatus comprising:
a computer processor and a data storage device, wherein the data storage device comprises a customer verification module and a transaction authorization module comprising non-transitory instructions executable by the processor to:
receive a transaction authorization request, wherein the transaction authorization request includes an indication of an account identifier, an indication of a unique personal identifier of a customer, and an indication of biometric data for the customer;
generate a customer verification request based on the unique personal identifier of the customer and the biometric data of the customer;
send the customer verification request to a biometric data authentication server;
receive a customer verification response from the biometric data authentication server; and
generate a transaction authorization response based on the customer verification response.

25. An apparatus according to claim 24, wherein the data storage device further comprises a customer look up module and a notification generation module comprising non-transitory instructions executable by the computer processor to look up customer contact information in a database and send a transaction notification to the customer using the customer contact information.

26. An apparatus according to claim 25, wherein the customer contact information includes a mobile telephone number associated with the customer, and wherein the transaction notification is sent as a text message.
